(19) United States
(12) Patent Application Publication
(10) Pub. No.: US 2025/0113175 A1
(43) Pub. Date: Apr. 3, 2025

(54) METHOD AND SYSTEM FOR OPERATING MULTI-SIM DEVICE WITH MULTIPLE RRC CONNECTION SUPPORT IN 5G NETWORK

(71) Applicant: SAMSUNG ELECTRONICS CO., LTD., Suwon-si, Gyeonggi-do (KR)

(72) Inventors: Aby Kanneath Abraham, Bangalore (IN); Vinay Kumar Shrivastava, Bangalore (IN); Jajohn Mathew Mattam, Bangalore (IN); Sriganesh Rajendran, Bangalore (IN)

(21) Appl. No.: 18/834,512

(22) PCT Filed: Feb. 1, 2023
(86) PCT No.: PCT/KR2023/001475

§ 371 Date: Jul. 30, 2024

(30) Foreign Application Priority Data
Feb. 1, 2022 (IN) 202241005477
Jan. 24, 2023 (IN) 202241005477

(51) Int. Cl. H04W 8/18; H04W 8/22; H04W 76/20; H04W 92/18

(52) U.S. Cl. CPC H04W 8/183; H04W 8/22; H04W 76/20; H04W 92/18

(57) ABSTRACT

The disclosure relates to a 5G or 6G communication system for supporting a higher data transmission rate. The present disclosure discloses a method and an apparatus for operating multi-sim device with multiple RRC connection support in the 5^{th} Generation (5G) Network (NW). In particular, a method includes detecting SIM actions in the second SIM when the first SIM is in active state or transitioning to active state. Once the SIM actions are detected, the method includes determining capability change information, of the first SIM, indicating information pertaining to change in capability of the first SIM which happens due to the SIM actions.

### TECHNICAL FIELD

The present disclosure relates, in general, to 5th Generation (5G) wireless communication. Particularly, but not exclusively, the present disclosure relates to a method and a system for operation of Dual Rx/Dual Tx Multi-Subscriber Identity Module (MUSIM) User Equipment (UE) in a 5G network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

Multi-SIM (MUSIM) devices, which host more than one Subscriber Identity Module (SIM) to have the facility to connect to two or more different Networks (NWs) in order to avail different data plans, and have user profiles like home and office, increased connectivity/reliability with multiple connections, etc., are becoming very popular. One or more of the multiple SIMs may be engaged in paging reception, System Information Block (SIB) acquisition, measurements, data or voice call, Multicast and Broadcast Service (MBS) reception, emergency call, Access Stratum (AS) signaling, Non-Access Stratum (NAS) signaling and so on.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Technical Problem

The present disclosure discloses a method for updating the change in the capabilities of the SIM due to the actions of another SIM of the user equipment.

### Solution to Problem

One or more shortcomings of the conventional systems are overcome by system and method as claimed and additional advantages are provided through the provision of system and method as claimed in the present disclosure. Additional features and advantages are realized through the techniques of the present disclosure. Other embodiments and aspects of the disclosure are described in detail herein and are considered a part of the claimed disclosure.

In one non-limiting embodiment, the present disclosure discloses a method for operating Multi-Subscriber Identity Module (multi-SIM) device provided with a first SIM and a second SIM The method comprises performing, upon detecting SIM actions in the second SIM when the first SIM is in active state or transitioning to active state, following steps. The method comprises determining capability change information associated with the first SIM. The capability change information indicates an information pertaining to change in capability of the first SIM happens due to SIM actions in the second SIM. The capability change information being informed by the first SIM to corresponding base station via Radio Resource Control (RRC) message. The method further comprises reconfiguring the first SIM based on at least one of RRC reconfiguration message and RRC Resume message received from the base station in accordance with the capability change information such that first SIM operates with new capabilities.

In another non-limiting embodiment, the present disclosure discloses an apparatus for operating a Multi-Subscriber Identity Module (multi-SIM) device provided with a first SIM and a second SIM. The apparatus comprises a memory and a circuitry in communication with the memory and configured to cause apparatus to perform, upon detecting SIM actions in the second SIM when the first SIM is in active state, the following operations. The circuitry causes the apparatus to determine capability change information associated with the first SIM. The capability change information indicates an information pertaining to change in capability of the first SIM happens due to SIM actions in the second SIM. The capability change information being informed by the first SIM to corresponding base station via Radio Resource Control (RRC) message. The circuitry further causes the apparatus to reconfigure the first SIM based on RRC reconfiguration message received from the base station in accordance with the capability change information such that first SIM operates with new capabilities.

The foregoing summary is illustrative only and is not intended to be in any way limiting. In addition to the illustrative aspects, embodiments, and features described above, further aspects, embodiments, and features will become apparent by reference to the drawings and the following detailed description. For a better understanding of exemplary embodiments of the present invention, together with other and further features and advantages thereof, reference is made to the following description, taken in conjunction with the accompanying drawings.

### Advantageous Effects of Invention

The present disclosure discloses operating a Multi-Subscriber Identity Module (multi-SIM) device. The present disclosure may update the change in the capabilities of the SIM due to the actions of another SIM of the user equipment. As a result, the change in the capabilities are timely updated to the corresponding base stations and the new capabilities of reconfigured the SIM whose capabilities are changed.

In other words, the base stations are aware of the capabilities of the connected one or more SIMs. The capability update allows the Multi-SIM device to share the various capabilities such as RF capabilities, physical layer capabilities among multiple SIMs dynamically. In the present disclosure, all the SIMs need to have the capabilities allocated statically. Even when the other SIMs are not using their capabilities, they cannot be allocated to the SIMs which need those capabilities.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for operating a Multi-Subscriber Identity Module (multi-SIM) device, in accordance with some embodiments of the present disclosure;

FIG. 2a illustrates a flow diagram for updating first SIM capability change to the network, in accordance with some embodiments of the present disclosure;

FIG. 2b illustrates a flow diagram for updating sidelink capability change to peer UE, in accordance with some embodiments of the present disclosure;

FIG. 2c illustrates a flow diagram for handling sidelink capability change by reconfiguring peer, in accordance with some embodiments of the present disclosure;

FIG. 2d shows the flowchart for a method of sidelink capability change-broadcast handling, in accordance with some embodiments of the present disclosure;

FIG. 2e illustrates a flow chart for an In-Device Interference handling for MUSIM, in accordance with some embodiments of the present disclosure; and

FIG. 3 illustrates a method of operating a MUSIM device provided with the first SIM and second SIM, in accordance with some embodiments of the present disclosure.

FIG. 4 illustrates the structure of a device according to an embodiment of the disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

The figures depict embodiments of the disclosure for purposes of illustration only. One skilled in the art will readily recognize from the following description that alternative embodiments of the structures and methods illustrated herein may be employed without departing from the principles of the disclosure described herein.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Disclosed herein are a method and an apparatus for operating a Multi-Subscriber Identity Module (multi-SIM) device. The MUSIM devices are designed to house two or more SIM cards. The SIM cards of the MUSIM device may connect with their corresponding networks to in order to avail different data plans, and have user profiles like home and office, increased connectivity/reliability with multiple connections, etc. Alternatively, one SIM card connects to the core mobile network, while another SIM card may connect to the network which may act as the back-up provider. As a result, this can help to ensure ongoing connectivity in case of a signal outage with the core provider. The present disclosure describes a method of operating a Multi-Subscriber Identity Module (multi-SIM) device provided with a first SIM and a second SIM. Initially, the first SIM may be in the active state or transitioning to active state and the SIM actions in the second SIM are detected. The SIM actions may include, for example, the second SIM transitioning from an idle state or an inactive state to an active state. Such transitioning of the second SIM affects the capability of the first SIM. Now the first task is to inform the network about the capability change information and then reconfigure the first SIM based on the capability change information. This way, the first SIM will operate with the new capabilities, and thus accommodating the second SIM in the MUSIM device.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

### <Multi-SIM Devices and Simultaneous RRC Connection Support>

Multi-SIM (MUSIM) devices, which host more than one Subscriber Identity Module (SIM) to have the facility to connect to two or more different Networks (NWs) in order to avail different data plans, and have user profiles like home and office, increased connectivity/reliability with multiple connections, etc., are becoming very popular. One or more of the multiple SIMs may be engaged in paging reception, System Information Block (SIB) acquisition, measurements, data or voice call, Multicast and Broadcast Service (MBS) reception, emergency call, Access Stratum (AS) signalling, Non-Access Stratum (NAS) signalling and so on.

One or more of the multiple SIMs may be engaged in sidelink communication as well. As opposed to the traditional wireless communication where all the data first flows towards the base stations like 5G gNB, in sidelink, devices can communicate directly with each other. Network controls the sidelink communication through configuration etc. Devices in sidelink communication exchange sidelink RRC messages over an interface such as PC5 interface. RRC message could be exchanged over PC5 interface for enquiring about sidelink capabilities, receiving sidelink capability information, reconfiguring the other device is sidelink communication, setting up or modifying or releasing sidelink radio bearers, releasing sidelink RRC connection etc.

There are different flavours of Multi-SIM devices like Single Rx-Single Tx, Dual Rx-Single Tx, Dual Tx-Single Rx, and Dual Rx-Dual Tx depending upon the number of Rx (Reception) chain and Tx (Transmission) chain. An Rx or Tx chain includes the RF circuitries and associated hardware and software components for reception and transmission respectively. A Dual Rx-Dual Tx device can normally support simultaneous Radio Resource Control (RRC) connections on its multiple subscriptions. These devices are also sometimes called Dual Stack-Dual Active (DSDA) devices. It may be also possible for Single Rx-Single Tx, Dual Rx-Single Tx, Dual Tx-Single Rx devices to support multiple simultaneous RRC connections through some methods for sharing their Rx and Tx chain and switching based on need.

### <User Equipment (UE) Capabilities>

In a technology like 5G New Radio (NR), different UEs may have different hardware and software capabilities. Varying capabilities across devices could be hardware capabilities including radio frequency capabilities like bands or band combinations supported, processing capabilities (for example, baseband computational capabilities), software capabilities like the support of various features, layer 1 capabilities, layer 2 capabilities, layer 3 capabilities and so on. In general, the UE reports its UE radio access capabilities which are static at least when the network requests the capabilities. To limit signalling overhead, the gNB (5G NR base station) may request the UE to provide NR capabilities based on a filter, for example, for a restricted set of bands. In NR, the UE may receive a RRC message known as UECapabilityEnquiry asking the UE to report the capabilities. UECapabilityEnquiry may contain a filter in an information Element (IE) known as capabilityRequestFilterCommon by which gNB informs UE about the capabilities it is interested in. NR UE reports capabilities based on the received filter. An example IE in NR RRC message for the said filter is given as follows.

```
  UE-CapabilityRequestFilterCommon ::= SEQUENCE {
  mrdc-Request SEQUENCE {
  omitEN-DC ENUMERATED {true} OPTIONAL, -- Need N
  includeNR-DC ENUMERATED {true} OPTIONAL, -- Need N
  includeNE-DC ENUMERATED {true} OPTIONAL -- Need N
  } OPTIONAL, -- Need N
  ...,
  [[
  codebookTypeRequest-r16 SEQUENCE {
  type1-SinglePanel-r16 ENUMERATED {true} OPTIONAL, -- Need N
  type1-MultiPanel-r16 ENUMERATED {true} OPTIONAL, -- Need N
  type2-r16 ENUMERATED {true} OPTIONAL, -- Need N
  type2-PortSelection-r16 ENUMERATED {true} OPTIONAL - Need N
  } OPTIONAL, -- Need N
  uplinkTxSwitchRequest-r16 ENUMERATED {true}
  OPTIONAL -- Need N
  ]],
  [[
  requestedCellGrouping-r16 SEQUENCE (SIZE (1..maxCellGroupings-
r16)) OF CellGrouping-r16 OPTIONAL -- Cond NRDC
  ]]
  }
  CellGrouping-r16 ::= SEQUENCE {
  mcg-r16 SEQUENCE (SIZE (1..maxBands)) OF FreqBandIndicatorNR,
  scg-r16 SEQUENCE (SIZE (1..maxBands)) OF FreqBandIndicatorNR,
  mode-r16 ENUMERATED {sync, async}
```

If supported by the UE and the network, the UE may provide an Identifier (ID) in Non-Access Stratum (NAS) signalling that represents its radio capabilities for one or more Radio Access Technology (RATs) in order to reduce signalling overhead. The ID may be assigned either by the manufacturer or by the serving Public Land Mobile Network (PLMN). The manufacturer-assigned ID corresponds to a pre-provisioned set of capabilities. In the case of the PLMN-assigned ID, the assignment takes place in NAS signalling. A detailed list of UE capabilities that are exchanged based on the aforementioned methods is specified in 3^{rd} Generation Partnership Project (3GPP) technical specifications like TS 38.306. This may include UE capability parameters for physical layer, parameters for link layers like RLC, MAC, PDCP or SDAP, sidelink parameters, parameters for measurement and mobility, parameters for application measurements, parameters for performance measurements etc. A 5G gNB provides a UE with various configurations/features through RRC messages like RRC reconfiguration or RRC resume based on the reported UE capability.

In the existing 3gpp systems like New Radio (NR) or Long Term Evolution (LTE), the above UE capabilities reported through the UE Capability exchange procedure are assumed not to change while the UE is attached or registered on the core network. If the capabilities are changed, UE may have to detach or deregister from the network and perform reattach or re-register again.

### <RRC States>

In NR, RRC may be in one of the three states like RRC_IDLE, RRC_INACTIVE or RRC_CONNECTED. An RRC_CONNECTED UE is in Connection Management (CM)-CONNECTED (i.e. connected to 5G core network) and can do unicast and multicast/broadcast traffic with the network. Network stores the UE AS context, knows the UE at the cell level and controls the UE mobility. UE may perform measurements and report to the network, provide channel quality and feedback information, etc. in RRC_CONNECTED state. Network may configure features such as dual connectivity, carrier aggregation etc. when a NR UE is RRC_CONNECTED.

RRC_INACTIVE is a state where a UE remains in CM-CONNECTED and can move within an area configured by NG-RAN (5G RAN consisting of gNB(s)) without notifying NG-RAN. In RRC_INACTIVE, the last serving gNB node keeps the UE context and the UE-associated NG connection (i.e. the connection to the core network). Since the RRC configurations and the connection to the core network are kept in RRC_INACTIVE, UE can transition immediately to RRC_CONNECTED state and perform data transfer with the core network/applications. UE initiates transition to RRC_CONNECTED from RRC_INACTIVE by sending RRC resume request.

In RRC_IDLE, UE or gNB doesn't store any Access Stratum (AS) context. UE is in CM_IDLE (there is no connection to the core network). UE sets up a new connection by sending an RRC setup request message and gNB sends an RRC setup message to transition to RRC_CONNECTED. UE and NW (both Radio Access Network (RAN) and core network) exchanges messages to move the UE to CM_CONNECTED.

When a Multi-SIM device supports multiple RRC connections, the UE capabilities supported by one or more of the Universal-SIMs (USIMs) (technically the radio protocol stack instance associated with the USIM) may vary based on whether other USIM is connected (RRC_CONNECTED). UE capabilities that may change between USIMs include the RF capabilities, processing capabilities, physical layer capabilities, layer 2 capabilities, RRC capabilities and so on.

Let us consider two USIMs-USIM-A (or UE-A) and USIM-B (or UE-B) and their corresponding network be NW-A (Network-A) and NW-B (Network-B). Network in the present invention mainly means NG-RAN though the core network is not excluded for some of the functionalities. Let us assume UE-A is in RRC_CONNECTED with NW-A. UE-B is in RRC_IDLE or RRC_INACTIVE and is transitioning to RRC_CONNECTED. Thereafter address how the UE-A indicates the changed capabilities to UE-B. UE-A also needs to indicate the changed capability once UE-B moves back to RRC_IDLE/RRC_INACTIVE. Further the capability change needs to be indicated to the network without the UE-A moving to a detached state or a deregistered state.

A related problem in the above example is applicable for UE-B. While UE-B is transitioning from RRC_IDLE/RRC_INACTIVE to RRC_CONNECTED, new UE capabilities might be different from the UE capabilities when the UE-B has moved to RRC_IDLE/RRC_INACTIVE last time (if UE-A has changed state while UE-B is in RRC_IDLE/RRC_INACTIVE). In the current NR system, the network considers the UE capabilities do not change unless UE performs a re-attach to the core network. For a MUSIM UE, this doesn't hold good and hence UE-B needs to inform NW-B if the capability has changed, and if changed what are the new capabilities, while transitioning to RRC_CONNECTED. In a MUSIM device, UE capabilities for an RRC connected UE, UE-A may change depending on various actions in UE-B. As a result, we have a problem on what actions on UE-B should be linked to the capability change in UE-A.

Another problem is how to support multi-connectivity, carrier aggregation, and so on when both the UEs are in RRC_CONNECTED. Similarly, methods are required to indicate the network support for capability change notification by the UE. Also, methods are required to indicate the capability changes related to a core network. The issues with respect to sending busy indications (or paging rejection) when the device supports multiple RRC connections need to be specified.

Another important aspect to be considered is the changes for sidelink capabilities and the related actions as well as UE behavior when the sidelink capability changes. For example, if UE-A supports sidelink operations and is performing the sidelink operations, it needs to inform the UE with which it is engaged in sidelink communication, that the sidelink capability has changed and both the UEs need to change their behavior accordingly.

Another aspect is related to In-Device-Coexistence (IDC). In a MUSIM UE, the transmission and reception of one USIM may affect the operations of other UE and it may not be possible for the UE alone to resolve this. Thus there needs to have some coordination with the network to handle the IDC scenarios.

In some cases, the capabilities of UE-A may change even if UE-B is non-connected and UE-B performs certain actions like receiving multicast or broadcast traffic or performing side-link operations. All the embodiments in the invention which refer to UE-B as non-connected or the transition of RRC state in UE-B are applicable for such cases also.

In some cases, the capabilities of UE-A may change while it is in RRC_IDLE or RRC_INACTIVE due to UE-A receiving multicast or broadcast traffic or performing side-link operations from NW-A itself. All the embodiments in this invention which refer to UE-B as non-connected or the transition of RRC state in UE-B is applicable for such cases also, irrespective of UE-A being a single USIM device or multi USIM device. This means any embodiment of the invention is applicable when capability change happens due to either UE-A or UE-B receives a broadcast or multicast traffic or performing side-link operations.

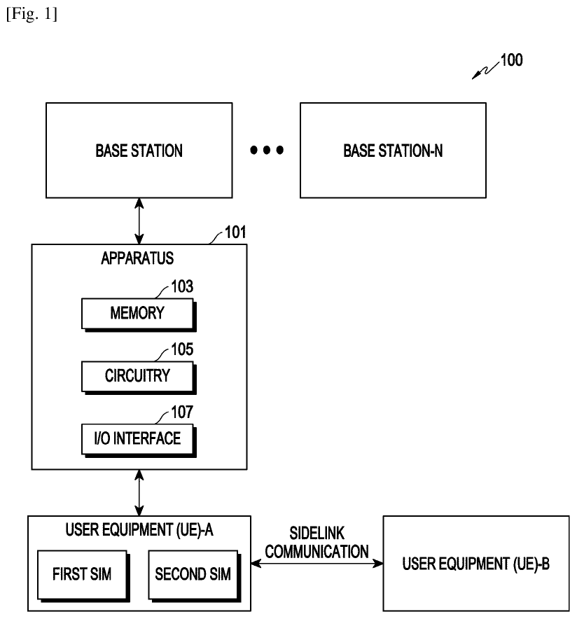

FIG. 1 shows an exemplary environment for operating a Multi-Subscriber Identity Module (multi-SIM) device in accordance with some embodiments of the present disclosure.

The environment 100 discloses an apparatus 101 between the MUSIM device and base stations. The environment 100 also shows the sidelink communication between one MUSIM device (UE-A) with another device (UE-B). Further, the apparatus 101 comprises comprising a memory 103, a circuitry 105 and an I/O interface 107. The UE-A comprises first SIM and the second SIM which is connected to its corresponding base stations. In NR, the base station is gNB. In LTE, the base station is eNodeB. Generally, mobile devices support use of two SIM cards, described as dual SIM operation. When a second SIM card is installed, the mobile device either allows users to switch between two separate mobile network services manually, has hardware support for keeping both connections in a “standby” state for automatic switching, or has individual transceivers for maintaining both network connections at once.

In some embodiments, the base stations may be a transmission and reception station in a fixed location, consisting of one or more receive/transmit antenna, microwave dish, and electronic circuitry 105, used to handle cellular traffic. Generally, the mobile devices require a network of base stations in order to function. The base station antennas transmit and receive RF (radio frequency) signals, or radio waves, to and from mobile devices near the base station.

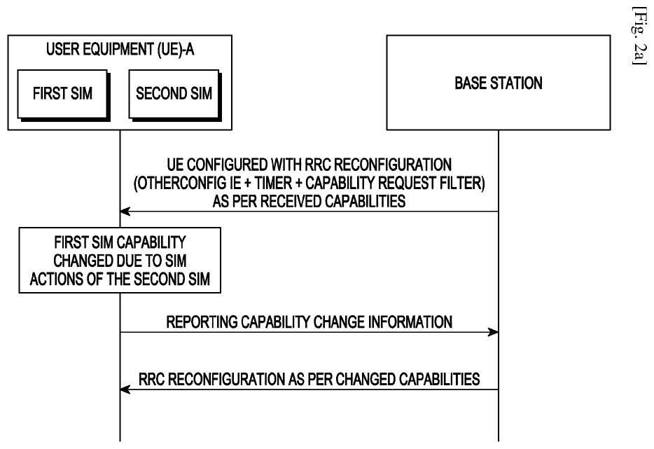

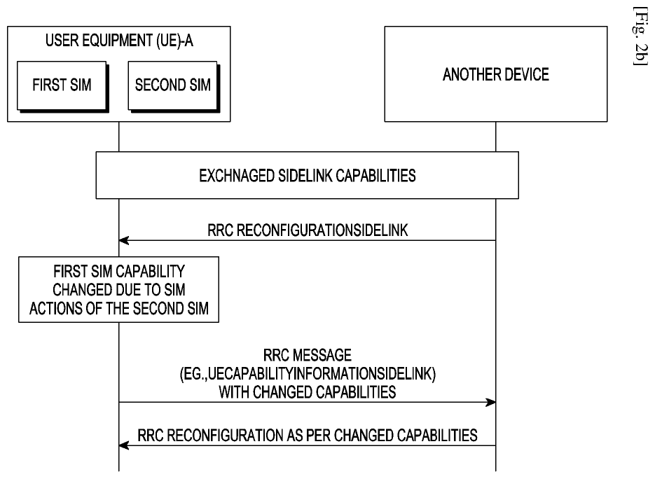

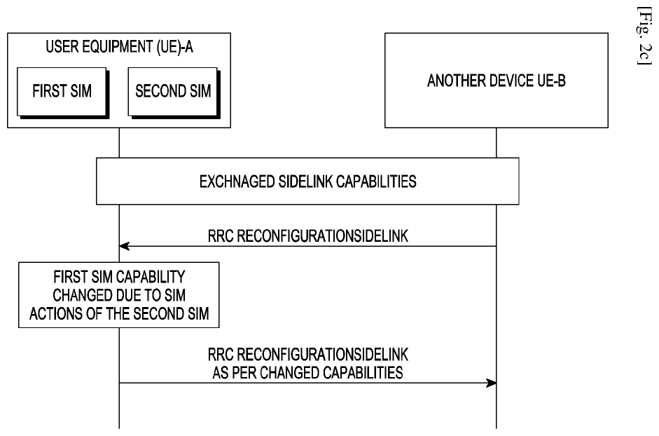

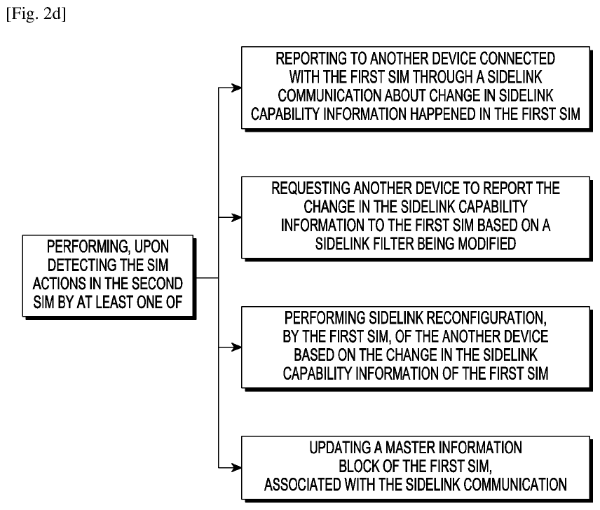

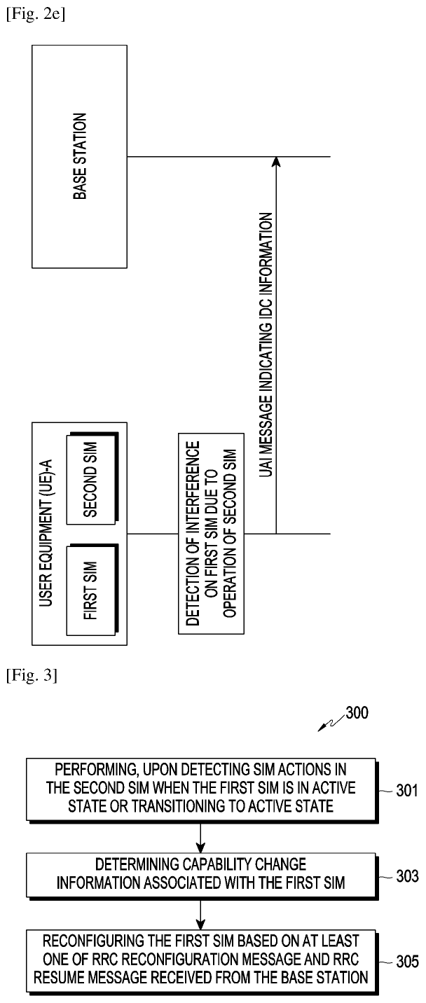

Typically, in a multi-SIM environment, the SIM operates by sharing network resources. If the UE is operating with only first SIM while the second SIM is inactive, then the first SIM will operate using a certain amount of network resources. However, when the second SIM gets activate, the capabilities of the first SIM changes. Such change pertains to resource sharing in the network. Hence, it becomes essential to inform the corresponding network or the base station about such capability change so that network understands the requirements and helps the first SIM to reconfigure itself. Moreover, the it is also important to inform the another device in the sidelink communication about such change. In the upcoming FIGS. 2a-2e, it is explained in detail how the first SIM informs the capability change information and reconfigure itself.

FIG. 2a illustrates a flow diagram for reporting change in the capability of first SIM to the corresponding base station, in accordance with some embodiments of the present disclosure.

In an embodiment, initially the first SIM will be configured with RRC configuration as per received capabilities from base station. Typically, the network or the base station stores the UE AS context, knows the UE at cell level and controls the UE mobility. The UE i.e. UE-A (shown in FIG. 2a) is provided with a first SIM and a second SIM. As described above the capability of one SIM changes when the another SIM gets activated or even deactivated. In the current example, a scenario is considered where the capability of the first SIM changes due to some SIM actions in the second SIM of the UE-A. Such SIM actions may include, for example, transitioning of the second SIM from one state to another, performing handover from one frequency range to another frequency range, or performing handover from licensed frequency band to unlicensed frequency band and vice-versa. All the above stated actions at the second SIM related to RF capabilities, processing capabilities, physical layer capabilities, RRC capabilities will affect the capabilities of the first SIM. The disclosed technique of informing the corresponding base station about the capability change information and subsequently reconfiguring itself will be triggered once any one of the SIM actions (described above) is detected.

However, before such triggering, the first SIM will receive RRC reconfiguration (RRC reconfiguration configuring MUSIM operation) which may include “OtherConfig information element”, “timer” and “capability request filter”. Each of these elements may be received in different RRC Reconfiguration messages or even in other RRC messages like RRC Resume message. Each of these elements will be explained in the upcoming section of the specification. The purpose of this initial RRC reconfiguration is to enable or instruct the first SIM to do reporting of its capability change information to the base station in a particular manner.

Now once the SIM actions is detected, the first SIM may report the updated or changed capabilities (capability change information) using Radio Resource Control (RRC) message to the base station to which the first SIM is connected.

In an embodiment, if the capability of first SIM has changed due to SIM actions of the second SIM when first SIM was in idle or inactive mode, first SIM indicates the new capabilities (i.e. capability change information) to its corresponding base station in RRC setup request/RRC resume request. In another embodiment, first SIM may also indicate just that the capability has changed in the RRC setup request/RRC resume request. Base station may request the first SIM to send the capability change information to which the first SIM may report in RRC messages like RRC setup complete or RRC resume complete. Further the base station may configure the first SIM further with the changed capabilities (not shown in FIG. 2a).

In an embodiment, when the first SIM is in RRC_CONNECTED mode or active state and the first SIM capability changes due to SIM actions of the second SIM, the first SIM informs corresponding base station about the capability change through the RRC message. In an embodiment, the change in capability may include, without limiting to, change in RF capabilities, processing capabilities, physical layer capabilities, RRC capabilities and the like. The RRC message comprises at least UEAssistanceInformation (UAI) or a new RRC message (for example, first SIM capability update), or even any existing RRC message. The first SIM may directly report the capability change information to the base station using the aforesaid RRC message. According to an embodiment, the UAI comprises information pertaining to multi-SIM assistance information or multi-SIM UE capability information.

Once the capability change information is received by the base station, base station retrieves the capability through a SIM capability retrieval procedure. The base station sends RRC reconfiguration message and RRC Resume message having the reconfiguration details to the first SIM. The base station may also store the received capability change information for its reference. While reporting to the base station and to reduce the signalling overhead, the first SIM may associate an unique identified (unique ID) with each set of the capability change information and share the unique ID as well to the base station. According to an embodiment, first SIM may share the unique ID indicating that the capability has changed. Using the unique ID information, the base station can retrieve the first SIM capability with the stored capabilities.

In an embodiment, the first SIM may report that the capability change information based on specific actions of second SIM. For example, when the second SIM is handed over from a licensed frequency to an unlicensed frequency or from one Frequency Range (FR) to another FR, the first SIM may report the capability change information to its corresponding base station.

Now referring back to the RRC reconfiguration configuring MUSIM operation, in which, the first SIM receives various information from the base station like “OtherConfig information element”, “timer” and “capability request filter” for enabling the first SIM to report the capability change information in a particular manner.

For example, first SIM receives configurations as a part of OtherConfig information element (OtherConfig IE) from the corresponding base station for enabling the first SIM to report about the capability change information to the corresponding base station. If the base station to which the first SIM is connected doesn't support the dynamic updation of capabilities or if the base station prefers not to change the capabilities for the UE as all the capabilities are required for the operation of the first SIM, it may not send the OtherConfig IE or may not send the request to report the capability change in OtherConfig and the first SIM will not report the capability change information accordingly. On the other hand, if the base station prefers to allow dynamically changing capability, it may send the OtherConfig IE and a request to report the capability change in the OtherConfig IE. Accordingly, the first SIM may report the updated or changed capabilities using the UE assistance information (UAI) message to the base station In other words, the first SIM reports the capability change information if it is configured by the base station to report the change in capabilities through OtherConfig. The information contents in UAI can pertain to MUSIM assistance information or MUSIM UE capability information.

In an embodiment, the first SIM may report the updated or changed capabilities using another RRC message than UAI. Similarly, in an alternative embodiment, the configuration for reporting the change in capability information may be received in a different IEs other than OtherConfig.

Further, configurations received from the corresponding base station also comprises a timer or prohibit timer which prohibits the first SIM from reporting the capability change information while the timer is running. The timer indicates a waiting time for the first SIM before reporting the capability change information to the corresponding base station, thereby reducing signaling between the first SIM and the corresponding base station. In other words, the timer may be configured to control how frequently the first SIM can report the capability change information to the base station. The first SIM starts the timer after sending the RRC message like UAI indicating a capability change information. If the UE capability changes while the timer is running, the first SIM doesn't send another UAI to report the capability change. Once the timer expires, the first SIM may send another UAI message to report the change in the UE capabilities. The capability update, for example, the scheduling pattern and/or Time Division Duplex (TDD) UL/DL config information pertaining to the second SIM as capability limitation (for example, number of Tx/Rx) to the first SIM is not static or fully prohibitive. The advantage of using the timer is to reduce signaling between the first SIM and the corresponding base station. In a specific case, where the first SIM has send UAI for the capability change information just before a handover, for e.g. 1 second before the handover, the first SIM may resend the UAI for the capability change information once the handover is completed, irrespective of the timer is running. Further, the timer may be restarted while the UAI is resend after handover while the timer is still running.

In an embodiment, the first SIM is configured to report the capability change information to the corresponding base station based on capability request filter. The capability request filter is either a part of the configurations received from the corresponding base station or a part of UECapabilityEnquiry message received by the first SIM from the corresponding base station. For example, if a capability is included in the filter changes, first SIM may report the capability change to the base station. If none of the capabilities in the filter change due to SIM actions of the second SIM, the first SIM may not report or may not initiate the messages to indicate capability changes. An example set of IEs that could be included in the filter can be requestedFreqBandsNRMRDC, requestedCapabilityNR, eutra-nr-only flag, and requestedCapabilityCommon, UE-CapabilityRequestFilterNR. Further, the present disclosure discloses that a source and target base station may exchange the capability change information and requested filter during a handover or transition from RRC_INACTIVE or any other Xn (where Xn is the interface between two base stations) information retrieval procedure.

In an embodiment, while being RRC Connected in NR, first SIM may receive NR UE Capability Enquiry Information from the corresponding base station including a filter in IE UE-CapabilityRequestFilterCommon. The first SIM reports the capabilities according to the received filter. Further the first SIM may go to RRC_IDLE mode. While going to RRC_IDLE, the first SIM stores the received filter IN UE-CapabilityRequestFilterCommon. Alternatively, the first SIM may store the reported capabilities. Later the first SIM moves to RRC_CONNECTED again and identifies that the capability has changed. The first SIM checks if the capability change has resulted in the change in last reported capabilities. i,e, the first SIM checks if the capability has changed based on the stored filter, for e.g. received in UE-CapabilityRequestFilterCommon or the stored last reported capabilities. If the capability change due to the other SIM action has resulted in a change in capability which was last reported (i.e. resulted in change in capability according to stored filter or the stored last reported capabilities), the first SIM reports the capability change information in UAI or other RRC message to the corresponding base station. If the capability change due to the other SIM action has not resulted in a change in capability which was last reported (i.e. resulted in change in capability according to stored filter or the stored last reported capabilities), the first SIM does not report the capability change information in UAI or other RRC message to the corresponding base station. The last reported capability could be the capability reported by the first SIM while it was in RRC_CONNECTED previously. The first SIM may transition between RRC_CONNECTED and other RRC states before reporting the change in capability due to other SIM action. The first SIM maintains one of last received filter or last reported capabilities during all these transitions.

In an embodiment, the first SIM receives the capability request filter in the configuration, for e.g. OtherConfig. If the capability change due to the other SIM action has resulted in a change in capability according to the received filter in OtherConfig, first SIM reports the capability change information in UAI or other RRC message to the corresponding base station. If the capability change due to the other SIM action has not resulted in a change in capability according to the received filter in OtherConfig, the first SIM doesn't reports the capability change information in UAI or other RRC message to the corresponding base station.

In an embodiment, the base station may also indicate if it supports one or more slices or services like V2X/MBS when simultaneous RRC connections are supported. The first SIM may request/inform the corresponding base station for releasing the said slice or service (or the RRC connection with NW-A) if the MUSIM device decides to allow establishing an RRC connection for the second SIM. If the MUSIM device decides to proceed with service/slice in the first SIM, second SIM RRC will inform the second SIM NAS that an RRC connection cannot be established. If the second SIM NAS has requested the RRC connection establishment due to a paging message, the second SIM NAS may send the busy indication to its Access and Mobility Management Function (AMF). In some implementations, the second SIM RRC may send the busy indication instead of second SIM NAS.

In an embodiment, the base station corresponding to the first SIM may add the filter based on whether Carrier Aggregation (CA) or Dual Connectivity (DC) is configured and whether CA/DC uses the bands for which capability changes, the current set of slices and services activated, whether MBS is activated, whether sidelink communication is activated, whether features like DAPS are supported, etc. If the bands supported by the changed capability are different from the older capability, the base station corresponding to the first SIM may reconfigure the first SIM to release one or more SCells, SCG or perform handover, etc. The base station corresponding to the first SIM may configure the first SIM to report any available measurements when the capabilities are changed. Since the changed capability can be different from the older capability, base station may prefer to change the SCells or SCG rather than release them, or in a case perform handover to a different frequency. Measurements from the UE (100) may aid the network to take such decisions. Thus, the capability change information comprises at least one of activation information, deactivation information and carrier release information. The activation information indicates information pertaining to a request made by the first SIM to the corresponding base station for activating one or more secondary cells for carrier aggregation or a secondary cell group for dual connectivity. The deactivation information indicates an information pertaining to a request made by the first SIM to the corresponding base station for deactivating one or more secondary cells for the carrier aggregation or a secondary cell group for the dual connectivity. Further, the carrier release information indicates information pertaining to a request made by the first SIM to the corresponding base station for releasing one or more secondary cells or a secondary cell group.

In an embodiment, whenever an RRC_CONNECTED SIM i.e., the first SIM reports the modified capabilities, it sends any available measurements to the corresponding base station. Measurements may be sent in the same RRC message which reports a change of capabilities or a different RRC message like a measurement report may be send along with the RRC message which reports a change of capabilities. If any of the NAS capabilities changes due to the second SIM changing RRC state, the first SIM may send a NAS message like a registration request and trigger a reregistration with the changed capabilities. As in the RRC case, if AMF may not support certain services with the capability change, the device needs to prioritize between services of the first SIM and the second SIM.

Further, the static or dynamic capability change information comprises information pertaining to at least one of: number of Rx links, number of Tx links, number of Multiple-Input Multiple-Output (MIMO) layers, Carrier Aggregation (CA) support, Dual-Connectivity (DC) support, processing capability, supported bands, supported band combinations, Time Division Duplex (TDD) Uplink (UL) or Downlink (DL) configuration, scheduling information, scheduling configuration, Discontinuous Reception (DRX) configuration, measurement configuration, In-Device Coexistence IDC related configuration, Power control or back-off parameters, Sidelink parameters, Band sidelink Parameters, and Band combination sidelink parameters.

As described above, the network or the base station utilizes the updated capability change information received from the first SIM and reconfigures the first SIM with updated parameters. The network or the base station may update the configuration of dual connectivity, carrier aggregation, power control, interference coordination, Dual Active Protocol Stack (DAPS) configuration, number of layers, and so on based on the capability change information including supported bands, supported band combination, scheduling pattern and/or TDD UL/DL config information, etc.

FIG. 2b illustrates a flow diagram framework for Sidelink UE capability change handling, in accordance with some embodiments of the present disclosure.

FIG. 2b shows a scenario where the first SIM reports about the sidelink capability information happened in the first SIM happened in the first SIM due to the SIM actions in the second SIM. The sidelink capability information is reported to the another device i.e. UE-B connected with the first SIM (of UE-A) through a sidelink communication. In an embodiment, first SIM reports to the another device (UE-B) connected with the first SIM through the sidelink communication about change in the sidelink capability information through PC5 RRC message like UECapabiltiyEnquirySidelink, or through PC5 RRC message UECapabilityInformationSidelink. The first SIM may also reconfigure UE-B through RRCReconfigurationSidelink. Similarly, the first SIM may receive PC5 RRC message RRCReconfigurationSidelink from UE-Band apply the received RRC reconfiguration message as shown in FIG. 2c.

In an embodiment, on change of sidelink capabilities of the first SIM, for example, due to the change in the RRC state of the second SIM, the first SIM may be configured to perform one or more of the following actions (shown in FIG. 2d) including, updating system information, sending updated capabilities and reconfiguring depending on the changed capabilities. That is:
a. The first SIM may report UE capabilities to another device i.e. UE-B through a PC5 RRC message. Updated capabilities may be sent in existing PC5 RRC message UECapabilityInformationSidelink or Sidelink UEInformationNR or any other PC5 RRC message, for example, new PC5 RRC message UECapabilityInformationUpdateSidelink may be defined for sending updated sidelink capabilities to another device i.e. UE-B (FIG. 2b).
b. The first SIM may request the another device i.e. UE-B to send the sidelink capabilities with a sidelink filter being modified (modified sidelink filter). The sidelink filter is received by the another device (UE-B) from the first SIM. The modified sidelink filter may remove some of the bands which were present in the previous configuration and add different bands. When change in the sidelink capability information of the first SIMs is due to increased its sidelink capabilities—(for example, when the second SIM moved from RRC_IDLE/RRC_INACTIVE to RRC_CONNECTED), the modified filter may have additional bands. In an implementation option, a single PC5 RRC message could be used by the first SIM to share its own updated sidelink capabilities and request the another device (UE-B) capabilities based on a different filter. The message may be UECapabilityInformationUpdateSidelink which is defined previously.
c. The sidelink reconfiguration may be performed, by the first SIM, for the another device based on the change in the sidelink capability information of the first SIM as shown in FIG. 2d.
d. The first SIM may broadcast updated system Information messages. For example, the first SIM may send MasterInformationBlockSidelink with updated fields like sl-TDD-Config or any other system information message with relevant parameters updated.
e. The first SIM may reconfigure another device based on the change in sidelink capability information. If any of the radio bearers configured by either of the first SIM or the another device (UE-B) are not supported or not preferred to be supported, the first SIM may release those radio bearers and send PC5 RRCReconfigurationSidelink message. Similarly, on receiving the sidelink capability information, the another device (UE-B) may also release some of the radio bearers and send PC5 RRCReconfigurationSidelink message.
f. In another case, the first SIM may reconfigure the another device (UE-B) with a new sidelink measurement configuration. For example, the first SIM may remove some of the measurement objects and corresponding measurement identities or report configurations either not supported or not required by the update capabilities. In the reverse case, when capability update adds new capabilities like new bands, the first SIM may add additional measurement objects, measurement identities, report configurations, etc. Similarly, on receiving the changed capabilities, another device (UE-B) also may modify the measurement configurations according to the updated capabilities from the first SIM and send RRCReconfigurationSidelink message.
g. If the sidelink communication with the another device is not sustainable or is not preferred, the first SIM may decide to perform RRC Release. The first SIM may send a PC5 RRC Release message to the another device (UE-B) or alternatively, decide to release the connection on its own.

### In Device Co-Existence

In an embodiment, upon detecting interference being faced by the first SIM due to an operation of the second SIM, the UAI message may be sent from the first SIM of the multi-SIM device to the corresponding base station. The UAI message will indicate In Device Co-existence information (IDC information) for one or more frequencies or frequency combinations of the first SIM which are being affected due to the operation of the second SIM or one or more frequencies or frequency combinations of the first SIM which are affecting the operations of the second SIM. According to an embodiment, the multi-SIM device is a victim system as shown in FIG. 2c.

FIG. 3 shows a method performed by an apparatus 101 operating a Multi-Subscriber Identity Module (multi-SIM) device, in accordance with some embodiments of the present disclosure.

As illustrated in FIG. 3, the method 300 includes one or more blocks illustrating a method of operating the multi-SIM device. The method 300 may be described in the general context of computer executable instructions. Generally, computer executable instructions can include routines, programs, objects, components, data structures, procedures, modules, and functions, which perform functions or implement abstract data types.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include performing, upon detecting SIM actions in the second SIM when the first SIM is in active state or transitioning to active state, the operations as described in the block 303 and block 305.

At block 303, the method 300 may include determining capability change information associated with the first SIM. The capability change information indicates an information pertaining to change in capability of the first SIM happens due to SIM actions in the second SIM. Further, the capability change information being reported by the first SIM to corresponding base station via Radio Resource Control (RRC) message.

At block 305, the method 300 may include reconfiguring the first SIM based on at least one of RRC reconfiguration message and RRC Resume message received from the base station in accordance with the capability change information such that first SIM operates with new capabilities.

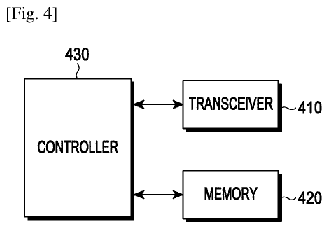

FIG. 4 illustrates the structure of a device according to an embodiment of the disclosure.

Each of the UE-A, the UE-B, the base station, the apparatus, the device, another device described with reference to FIG. 1 to FIG. 3 may correspond to the device in FIG. 4. Referring to FIG. 4, the device may include a transceiver 410, a memory 420, and a controller 430.

According to the communication method of the device described above, the transceiver 410, the controller 430, and the memory 420 of the device may operate. However, components of the device are not limited to the above-described example. For example, the device may include more components or less components than the above-described components. Moreover, the transceiver 410, the controller 430, and the memory 420 may be implemented as a single chip. In addition, the controller 430 may include at least one processor.

The transceiver 410 refers to a combination of the receiver of the device and the transmitter of the device, and may transmit/receive signals with other devices. To this end, the transceiver 410 may include an RF transmitter configured to up/convert and amplify frequencies of transmitted signals, an RF receiver configured to low-noise-amplify received signals and to down-convert frequencies, and the like. However, this is only an embodiment of the transceiver 410, and components of the transceiver 410 are not limited to the RF transmitter and the RF receiver.

In addition, the transceiver 410 may receive signals through a radio channel, may output the same to the controller 430, and may transmit signals output from the controller 430 through the radio channel.

The memory 420 may store programs and data necessary for operations of the device. In addition, the memory 420 may store control information or data included in signals acquired by the device. The memory 420 may include a storage medium such as a read only memory (ROM), a random access memory (RAM), a hard disk, a compact disc-ROM (CD-ROM), and a digital versatile disc (DVD), or a combination of such storage media. In addition, the memory 420 may not exist separately and may be included in the controller 430.

The controller 430 may control a series of operations such that the device can operate according to an embodiment described above.

1. A method by a user equipment (UE) including a first subscriber identity module (SIM) and a second SIM, the method comprising:
identifying that the UE is in a radio resource control (RRC) connected state;
identifying whether UE capability associated with the first SIM changes due to action in the second SIM; and
transmitting, to a base station via a RRC message, information on the UE capability associated with the first SIM as a response to the identifying that the UE capability associated with the first SIM changes due to the action in the second SIM,
wherein the information on the UE capability includes information on carrier aggregation (CA) or dual connectivity (DC) capability.

2. The method of claim 1, wherein the information on the UE capability comprises information at least one of:
number of Rx links,
number of Tx links,
number of Multiple-Input Multiple-Output (MIMO) layers,
supported bands,
supported band combinations, and
Power control parameters.

3. The method of claim 1, wherein the RRC message comprises UE assistance information (UAI) for reporting the information on the UE capability associated with the first SIM.

4. The method of claim 1, further comprising:
transmitting, to the base station, a UE capability update request message; and
receiving, from the base station via a RRC signaling, a UE capability enquiry message for enquiring the information on the UE capability.

5. The method of claim 1, further comprising:
receiving, from the base station, other config information element (OtherConfig IE) for enabling the first SIM to report the information on the UE capability.

6. The method of claim 1, wherein the information on the UE capability comprises at least one of activation information, deactivation information and carrier release information,
wherein the activation information indicates information for activating one or more secondary cells,
wherein the deactivation information indicates information for deactivating one or more secondary cells, and
the carrier release information indicates information for releasing one or more secondary cells.

7. The method of claim 1, further comprising:
transitioning the second SIM from the one state to the another state when the first SIM is in the active state comprises at least one of:
transitioning of the second SIM from an inactive state to an active state; and
transitioning of the second SIM from an active state to an inactive state.

8. The method of claim 1, further comprising:
reporting, by the first SIM, to another UE connected with the first SIM through a sidelink communication about change in sidelink capability information happened in the first SIM;
requesting, by the first SIM, another UE to report the change in the sidelink capability information to the first SIM based on a sidelink filter being modified, wherein the sidelink filter is received by the another UE from the first SIM;
performing sidelink reconfiguration, by the first SIM of the another UE based on the change in the sidelink capability information of the first SIM; and
updating a master information block of the first SIM, associated with the sidelink communication, wherein the master information block is being broadcasted by the first SIM.

9. The method of claim 5, wherein a timer which prohibits the first SIM from reporting the information on the UE capability while the timer is running is configured, and
wherein the timer indicates a waiting time for the first SIM before reporting the information on the UE capability to the base station, thereby reducing signaling between the first SIM and the base station.

10. The method of claim 5, wherein the first SIM is configured to report the information on the UE capability to the base station based on capability request filter, and
wherein the capability request filter is either a part of configurations received from the base station or a part of UE Capability Enquiry message received by the first SIM from the base station.

11. The method of claim 1, wherein the action in the second SIM comprises at least one of transitioning of the second SIM from one state to another, performing handover from one frequency range to another frequency range, performing handover from licensed frequency band to unlicensed frequency band and vice-versa.

12. A user equipment (UE) including a first subscriber identity module (SIM) and a second SIM, the UE comprising:
a transceiver; and
a controller coupled with the transceiver and configured to control to:
identify that the UE is in a radio resource control (RRC) connected state,
identify whether UE capability associated with the first SIM changes due to action in the second SIM, and
transmit, to a base station via a RRC message, information on the UE capability associated with the first SIM as a response to the identifying that the UE capability associated with the first SIM changes due to the action in the second SIM,
wherein the information on the UE capability includes information on carrier aggregation (CA) or dual connectivity (DC) capability.

13. The UE of claim 12, wherein the information on the UE capability comprises information at least one of:
number of Rx links,
number of Tx links,
number of Multiple-Input Multiple-Output (MIMO) layers,
supported bands,
supported band combinations, and
Power control parameters.

14. The UE of claim 12, wherein the RRC message comprises UE assistance information (UAI) for reporting the information on the UE capability associated with the first SIM.

15. The UE of claim 12, wherein the controller is configured to control to:
transmit, to the base station, a UE capability update request message, and
receive, from the base station via a RRC signaling, a UE capability enquiry message for enquiring the information on the UE capability.
